(19) United States
(12) Patent Application Publication
(10) Pub. No.: US 2008/0001396 A1
(43) Pub. Date: Jan. 3, 2008

(54) Pipe coupling and method

(76) Inventors: Randy W. Nish, Provo, UT (US); Randy Jones, Park City, UT (US); Carl Kirkland Wells III, Baton Rouge, LA (US)

Correspondence Address: Robert Lundstrom;Thorpe North and Western, Suite 200, 8180 South 700 East, Sandy, UT, 84070--056, US

(21) Appl. No.: 11/784,498

(22) Filed: Apr. 6, 2007

Related U.S. Application Data
(60) Provisional application No. 60/790,041, filed on Apr. 7, 2006.

(51) Int. Cl. F16L 11/12

(52) U.S. Cl. 285/53

(57) ABSTRACT

A pipe joining system used to join abutting fiberglass or composite pipe ends. The pipe joining system includes a gasket that is sized and shaped to fit around and seal an interface between the abutting pipe ends and at least one fibrous annulus that is sized and shaped to fit around the pipe ends and cover the gasket. The fibrous annulus includes dry fibrous reinforcement material capable of receiving resin. A sleeve can circumscribe the gasket and the at least one fibrous annulus.

### PRIORITY CLAIM

This application claims benefit of U.S. Provisional Application No. 60/790,041 filed Apr. 7, 2006, which is herein incorporated by reference in its entirety for all purposes.

### BACKGROUND OF THE INVENTION

1. Field of the Invention

The present invention relates generally to coupling pipe together and more particularly to coupling the ends of two fiberglass or composite pipes together.

2. Related Art

Fiberglass pipes are currently used in a variety of applications. For example, off shore oil rigs use fiberglass pipes to transport water for deluge fire suppression systems that use large amounts of water from the ocean because fiberglass pipes don't corrode from exposure to salty ocean water. Similarly, fiberglass pipes can also be used to transport portable and waste water on ships because fiberglass pipes are resistant to corrosive fluids and atmospheric environments, such as marine atmospheres.

Joining fiberglass pipes can be problematic. One current method for joining fiberglass pipes includes a “butt wrap” which involves placing two pipe ends together, beveling or skiving the ends, filling the gap between the pipe with a thermosetting material, wrapping the two pipe ends with a fiberglass fabric, and coating the wrap with a resin. One problem with this system is that the resins used to wet and seal the fiberglass fabric generally have a noxious or offensive odor. This has been especially problematic in confined ship hold environments that don't have good ventilation. Even in the open air environments of off shore oil rigs, these resins are generally mixed away from their point of application and moved to the pipes later in order to minimize the odor at the work site.

Another problem is that piping is often located in small and tightly packed spaces where it is difficult to wrap the pipes. This is especially problematic where pipes are already in place and need to be repaired or spliced. Since pipes are generally run alongside walls or other pipes, it will be appreciated that manipulating the fiberglass fabric in and around the pipe is extremely difficult. Additionally, since the pipe and fiberglass fabric usually have to be wetted with resin before application of the fabric to the pipe, wrapping the pipe with the fabric can result in an uneven wrap with poor quality that can leak or structurally fail.

### SUMMARY OF THE INVENTION

It has been recognized that it would be advantageous to develop a method and device for joining fiberglass or composite pipes in confined spaces that minimizes exposure of the confined space to noxious odors. In addition, it has been recognized that it would be advantageous to develop a method and device for joining fiberglass or composite pipes in small and tightly packed spaces.

The present invention provides a pipe joining system used to join abutting fiberglass or composite pipe ends. The pipe joining system can include a gasket that is sized and shaped to fit around and seal an interface between the abutting pipe ends. At least one fibrous annulus can be sized and shaped to fit around the pipe ends and cover the gasket. The fibrous annulus can include dry fibrous reinforcement material capable of receiving resin. A sleeve can circumscribe the gasket and the at least one fibrous annulus.

In another more detailed aspect of the present invention at least one locking ring can be disposed in the at least one fibrous annulus. The at least one locking ring can extend radially from the at least one fibrous annulus to engage an outer diameter of the fiberglass or composite pipe to restrict longitudinal movement of the at least one fibrous annulus axially along the fiberglass pipe.

In yet another more detailed aspect of the present invention, at least one injection port can be disposed in the reinforcing sleeve. The injection port can be configured to infuse resin into the fibrous annulus.

The present invention also provides for a method for joining fiberglass pipes including abutting two fiberglass or composite pipe ends adjacent one another to form a butt joint. A dry fibrous material can be dry wrapped around the butt joint. A flat sheet of reinforcing material can be wrapped around the dry fibrous material to form a reinforcement sleeve circumscribing the butt joint with distal ends extending beyond the dry fibrous material. The distal ends of the sleeve can be sealed to the fiberglass or composite pipes to encapsulate the dry fibrous material. Resin can be introduced to the fibrous material through an injection port in the reinforcement sleeve. The resin can be allowed to cure.

The pipe joining systems of the present invention also provide for other advantages. For example, the resin can be injected into the ports, flow around the circumference of the pipes and also flow axially along the pipes in order to fill the fiber annulus filling the area or cavity within the reinforcing sleeve. Resin can exit a bleed port to indicate that the cavity is filled with resin. Additionally, as the resin flows into the cavity, the resin wets out a prepared fiberglass surface of the pipes which helps bond the fibrous annulus to the fiberglass pipes. Furthermore, as the resin flows around the locking rings and cures, a mechanical interference is formed that supplements the shear strength of the bond. Moreover, the resin infused laminate can act to support and restrict the gasket to assure a quality, long-term seal about the abutting pipe end interface. It will also be appreciated that the joining system and method described herein can be used on other types of pipe, including composite or fiber reinforced pipe, or pipe formed of other materials, including metal and plastic.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a perspective view of a fiberglass or composite pipe joining device in accordance with an embodiment of the present invention;

FIG. 2 is a cross sectional view of the fiberglass or composite pipe joining device of FIG. 1; and

FIG. 3 is a cross sectional view of another fiberglass or composite pipe joining device in accordance with an embodiment of the present invention;

FIG. 4 is a perspective view of the pipe joining device of FIG. 1 enclosed in a pipe clamp;

FIG. 5 is a cross section view of the pipe joining device and pipe clamp of FIG. 4;

FIG. 6 is an end view of the pipe joining device and pipe clamp of FIG. 4;

FIG. 7 is a top view of the pipe joining device and pipe clamp of FIG. 4;

FIG. 8 is a side view of the pipe joining device and pipe clamp of FIG. 4;

FIGS. 9-13 illustrate a method for joining fiberglass or composite pipes using the pipe joining device of FIG. 1;

FIGS. 14-19 illustrate a method for forming a fiberglass or composite pipe joint in accordance with another embodiment of the present invention;

FIG. 20 is a perspective view of the fiberglass or composite pipe joint formed in accordance with the method illustrated in FIGS. 14-19 and

FIG. 21 is a cross section view of a pipe joining system in accordance with another embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The embodiments of the present invention described herein provide generally for a system for joining or coupling fiberglass or composite pipes. The system can include a gasket that fits around the pipes that extends from the end of one pipe to the end of another pipe. The gasket can form a connection between the two pipes and also seals the two pipes together. The gasket can have an annular internal cavity exposed to the internal space of the pipes so that fluid that may escape through the interface between the pipes can be captured and contained within the internal cavity. The gasket also prevents resin injected into the fibrous annulus from seeping into the gap between the pipes and into the inner diameter of each pipe. A fibrous annulus or cylinder can fit over the pipes adjacent the gasket, and a reinforcing sleeve can enclose or encapsulate the fibrous annulus and the gasket. The sleeve can have at least one injection port into which an injection resin tool can be coupled and resin can be injected into the fibrous annulus. The resin can fill the sleeve and wet the fibrous annulus. The resin can cure to form a fiberglass reinforcement coupling joining the two pipes together. Additionally, a locking ring, such as a snap ring, can be disposed at least partially between the fibrous annulus and the outer diameter of the pipe. The locking ring can restrict movement of the fibrous annulus along the longitudinal axis of the pipes.

As illustrated in FIGS. 1-3, pipe joining system, indicated generally at 10, in accordance with the present invention is shown for use forming a sealed coupling between two fiberglass pipes 12 by joining abutting ends of the fiberglass pipe. The joining system 10 can couple the two pipes 12 together, end to end, and can seal the interface between the two abutting pipe ends 14.

The joining system 10 can include a gasket 20 that can be sized and shaped to fit around and seal the abutting pipe ends 14. The gasket 20 can include a soft elastomeric material that can conform to the shape of the pipe. In one aspect, the gasket 20 can include a gap filling material such as putty. In another aspect, the gasket 20 can include a gap covering material such as tape. In yet another aspect, the gasket 20 can be formed of an elastomeric material such as rubber that can be sized and shaped to fit over the outer diameter of the pipe.

In one aspect, the gasket 20 can have internal geometric features, such as an annular pressure relief cavity 24 that can be in fluid communication with the interface between the two pipe ends 14. It will be appreciated that when the pipes 12 are pressurized, fluid contained within the pipes can be forced out of the pipes between the interface between the abutting pipe ends. Thus, the internal cavity 24 can advantageously be positioned to capture and contain fluid escaping from the interface between the two abutting pipe ends. Additionally, the gasket geometric features can increase the sealing forces acting against the pipe outer diameter as internal or external pressures increase.

The joining system 10 can also include at least one fibrous annulus 30 that can be sized and shaped to fit around the pipe ends 14 adjacent the gasket 20. The fibrous annulus 30 can be formed from a composite material such as fiberglass, carbon fiber, silica fiber, graphite fiber, and the like. Additionally, the fibrous material of the annulus can include an insulative material, or be formed of a fiber that has insulating properties. The fibrous annulus 30 can be a woven fiber cloth, a chopped fiber matt, a fiber lay-up, a fiber winding, or the like. The fibrous annulus 30 can include dry fiberglass that can be wetted with a resin during installation. In one aspect, the fibrous annulus 20 can have an annular groove to receive the gasket 20.

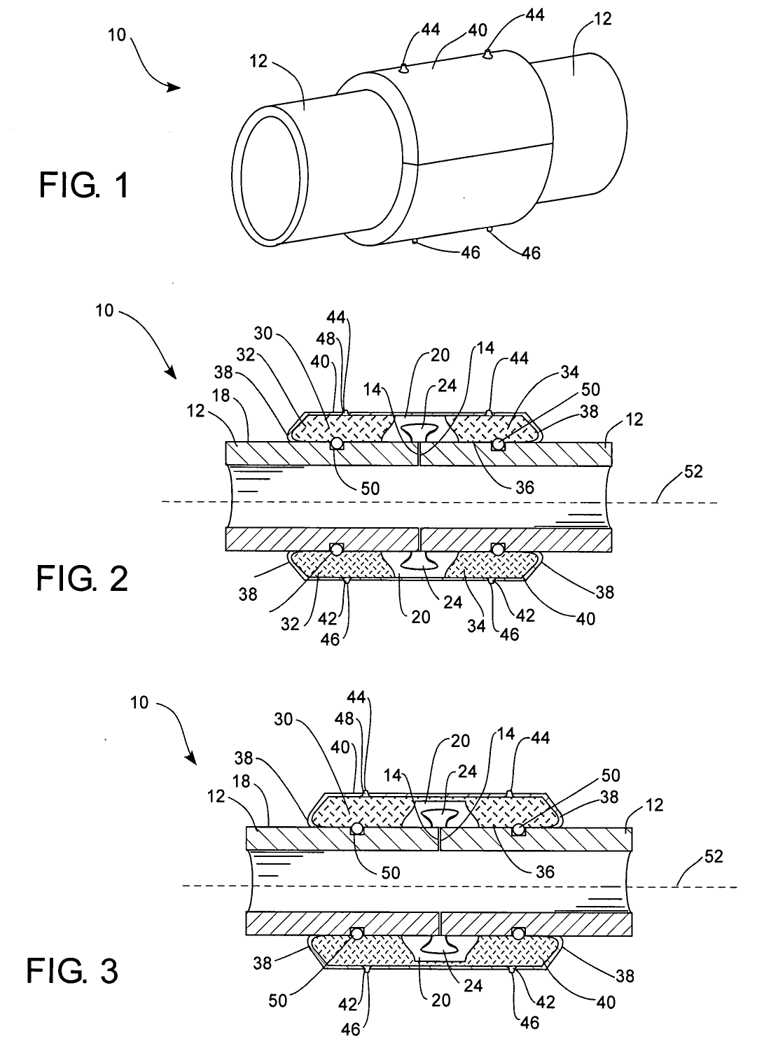

In one aspect, the joining system 10 can have two fiber glass annuluses 32 and 34 that can be disposed on either side of the gasket 20, as shown in FIG. 2. In another aspect, the fibrous annulus 30 can have an internal relief to accommodate the location of the gasket, and the fibrous annulus can extend over the gasket relief in order to lie on either side of the gasket, as shown in FIG. 3. In either case, the fibrous annulus 30 or annuluses 32 and 34 can be preformed cylinders formed from fibers commonly used in fiberglass piping systems. The annulus 30 or annuluses 32 and 34 can also extend over the gasket 20 to provide additional strength and thermal insulation.

A reinforcing sleeve 40 can circumscribe the gasket 20 and the at least one fibrous annulus 30. The reinforcing sleeve 40 can include a high strength material to clamp, seal and reinforce the pipe joint against unwanted movement and loading such as bending, torsional loading, and the like. In one aspect, the reinforcing sleeve can include a metal material such as steel, stainless steel, copper, aluminum, or the like. In another aspect, the reinforcing sleeve can include a composite material such as fiberglass reinforced phenolic, fiberglass reinforced vinyl ester, reinforced fiberglass polyester, reinforced fiberglass epoxy, and the like. In yet another aspect, the sleeve can include a relatively flexible material such as a plastic or elastomeric polymer. It will be appreciated that various combinations of these materials can also be used to form the reinforcing sleeve. Additionally, other high strength materials, as known in the art, can be used to form the reinforcing sleeve.

The reinforcing sleeve 40 can cover and encapsulate the fibrous annulus 30, and resin applied thereto. In one aspect, the sleeve 40 can have distal internal annular flanges extending to the pipe. In another aspect, the sleeve can have flexible distal ends that can be deformed or deflected to the pipe.

The reinforcing sleeve 40 can include at least one resin injection port 44. The resin injection port 44 can be disposed in the reinforcing sleeve and include an aperture 48 that can extend through the reinforcing sleeve. The aperture can provide access to the fibrous annulus 30 encased within the reinforcing sleeve 40. In the sleeve is metal, the sleeve can also have curved ends 38 that can resist pressure for infusion of the resin through the port. The curved ends can include an elastomeric material such as rubber to seal against the pipes and prevent resin leakage. Thus, in use, the aperture 48 can direct resin injected through the resin injection port 44 into the fibrous annulus 30, and the curved ends 38 can contain the resin within the metal case 30.

The reinforcing sleeve 40 can also include at least one bleed port 46. In one aspect, the bleed port 46 can be located opposite, or 180 degrees from the resin injection port 44 on the reinforcing sleeve 40. The bleed port can include an aperture 42 through the reinforcing sleeve 40. Other bleed ports can also perforate the metal sleeve and can be located at 90 or 270 degrees from the resin injection port. The bleed port 46 can release resin from the fibrous annulus 30 so that as resin is injected through the at least one injection port excess resin is pushed out the bleed port. The bleed port 46 can also be connected to a vacuum source (not shown) so that a vacuum or negative pressure differential can be formed about the fibrous annulus 30 in order to draw and infuse resin into the fibrous annulus.

Advantageously, the reinforcing sleeve 40 can encapsulate the fibrous annulus 30 to reduce odor from resin injected into the fibrous annulus. It will be appreciated that many resins used to wet composite fiber articles have pungent, noxious or even toxic odors. Thus, it is a particular advantage that the reinforcing sleeve 40 described herein can act as a containment device for resin injected into the fibrous annulus, and can contain not only the resin, but also the odor associated with the resin, thereby minimizing the noxious smell associated with joining fiberglass or composite pipes.

Additionally, the reinforcing sleeve can protect the fibrous annulus 30, resins, gasket 20, and pipe 12 from heat degradation due to temperature extremes or fire. Thus, the reinforcing sleeve 40 provides a fire resistant shell to the joining system and can reduce smoke emissions in the event of a fire. It will be appreciated that a flame resistant, low smoke and low toxicity sleeve allows injection of the joint with low cost commonly used resins, without jeopardizing the flame resistant, smoke and toxicity properties needed by shipboard piping systems.

The joining device 10 can also include at least one locking ring 50, such as a snap ring. The locking ring 50 can be a separated ring that can be disposed on an internal diameter 36 of the at least one fibrous annulus 30, and can circumscribe the outer diameter of the pipes 12. The fibrous annulus circumscribes the locking ring while the locking ring circumscribes the pipe. The locking ring can extend into the annulus and/or the pipe. In one aspect, the locking ring can be a metal ring, such as stainless steel. In another aspect, the locking ring can be formed of a composite material such as a material similar in composition to the pipe 12 or the fibrous annulus 30.

The locking ring 50 can extend from the inner diameter 36 of the fibrous annulus 40 and engage and outer diameter 18 the fiberglass pipe 12. In one aspect, the locking ring 50 can fit into a groove 58 machined into the outer diameter 18 of the fiberglass pipe. The locking ring can also extend into a groove in the annulus.

The locking ring 50 can restrict movement of the joining system 10 along the longitudinal axis, shown by dashed line 52, of the pipe 12 by restricting longitudinal movement of the at least one fibrous annulus 30 along the fiberglass pipe 12. In one aspect, the joining device can have a locking ring 50 associated with each of the two abutting pipes 12. In this case, each locking ring 50 can be disposed between the fibrous annulus 30 and the outer diameter 18 of the pipe to restrict longitudinal movement of the joining device 10 along the pipe.

In use, as resin is introduced into the fibrous annulus 30 through the resin injection port 44. The resin can flow through the port 44 and into the fibrous annulus 30, thereby wetting the fibers of the fibrous annulus. The resin can flow around the pipe 12 and fill the reinforcing sleeve 40. When the reinforcing sleeve 40 is full of resin, excess resin can flow out of the bleed port 46. Advantageously, the bleed port 46 can be positioned opposite the injection ports 44 so that excess resin flowing from the bleed ports can indicate complete fill of the reinforcing sleeve 40. The resin can also flow around the locking ring 50, thereby cementing the ring into place and sealing the space around the ring.

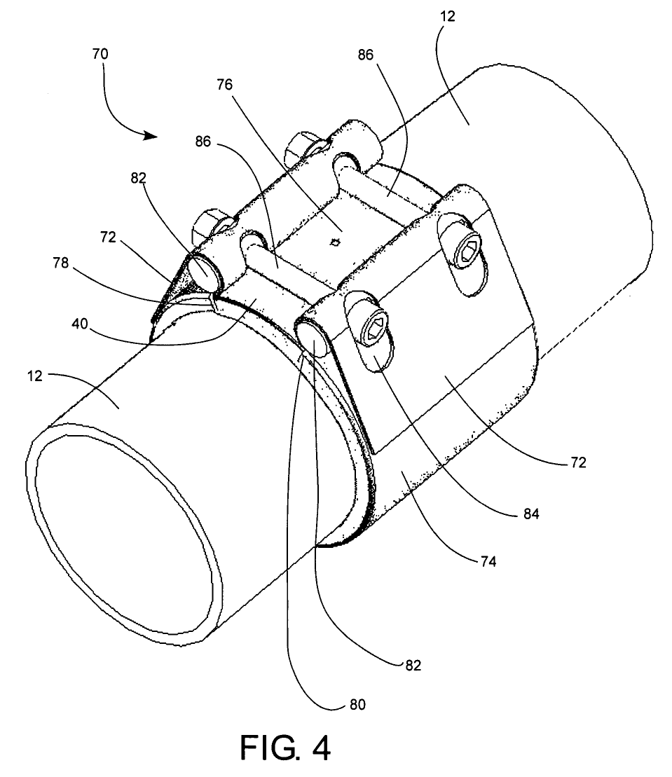

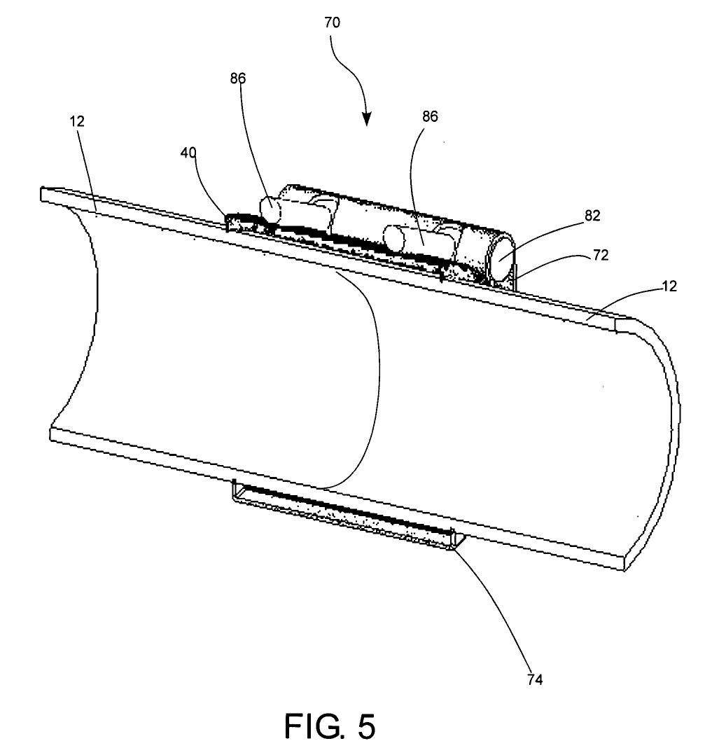

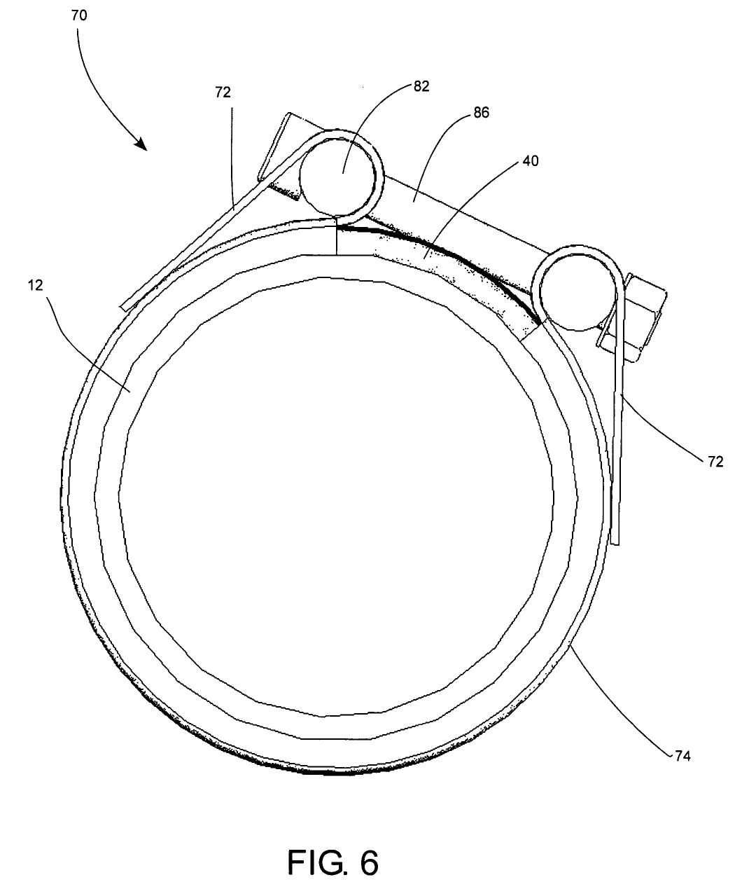

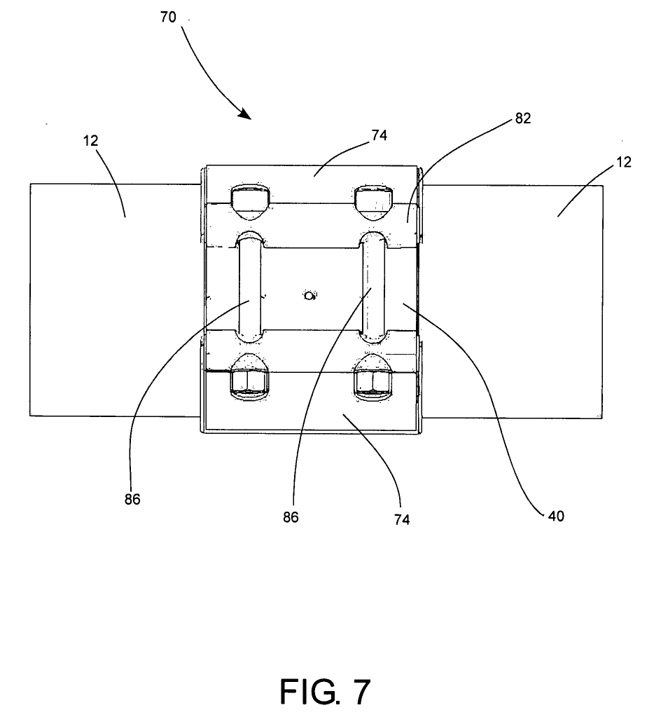

Referring to FIGS. 4-8, the joining device 10 can also include a pipe clamp, indicated generally at 70, to hold the reinforcing sleeve 40 and fibrous annulus 30 in place while the resin cures. The pipe clamp 70 can include a pair of brackets 72. Each bracket 70 can be coupled to a reinforcing sleeve clamp 74. The reinforcing sleeve clamp 74 can be a band having a gap 76 between two ends 78 and 80. The reinforcing sleeve clamp 74 can fit around the reinforcing sleeve 40.

Each bracket 70 can also have a reinforcement rod 82. Each reinforcement rod 82 can have at least one hole 84 that can be sized and shaped to hold a threaded fastener 86, such as a bolt, or the like. The threaded fastener 86 can extend through the hole 84 in one reinforcement rod 82, across the gap 76 between the ends 78 and 80, and through the hole 84 in the other reinforcement rod 82. The threaded fastener 86 can be turned to increase or decrease the gap between the ends of the reinforcing sleeve clamp 74. As the threaded fastener 86 is turned to decrease the gap 76, the metal housing clamp 74 is tightened about the reinforcing sleeve 40. Similarly, as the threaded fastener 86 is turned to increase the gap 76, the reinforcing sleeve clamp 74 is loosened about the reinforcing sleeve 40. In this way the reinforcing sleeve 40 and the fibrous annulus 30 can be held securely in place on the two pipes 12. The pipe clamp 70 is one means for clamping the metal housing 40 and fibrous annulus 30 around the pipes 12. Other means for clamping about a pipe can also be used.

Advantageously, the pipe clamp 70, or portions thereof, can be removable and reusable. It will be appreciated that once the resin cures, the fibrous annulus 30 and the reinforcing sleeve 40 may be bonded into place on the pipes 12 and the clamping force may no longer be needed to secure the joining device 10 to the pipes. Consequently, the pipe clamp 70 can be removed from the joining device and reused on another joint or coupling. In this way the joining device 10 need not include the expense of the clamping device.

Alternatively, the clamp 70 can be left in place and can provide a more aesthetic appearance to the joining device 10. Advantageously, being able to provide a more aesthetic appearance to the pipe joint minimizes sanding and other rework of the joining device, thereby reducing the production of airborne fiberglass particulates that can cause irritation to people. Moreover, a neat appearance of the joining device 10 can allow fiberglass pipes and couplings to be used on luxury yachts, ships and ocean liners.

It is a particular advantage of the joining device 10 of the present invention that the joint created on the fiberglass pipe has a greater ability to resist undesirable loading, such as bending, torsional loading, or the like, due to flexure of the fiberglass pipe, pressure from the pipe contents, or other external forces. In contrast, pipe slips and unions commonly used to join plastic, composite, or metal pipes provide little added structural benefit to the pipe system, and often have sealing problems. In the present invention, the flexibility of the gasket combined with the strength of the fibrous annulus and the reinforcing sleeve both seal the joint and provide additional structural strength to the pipe system.

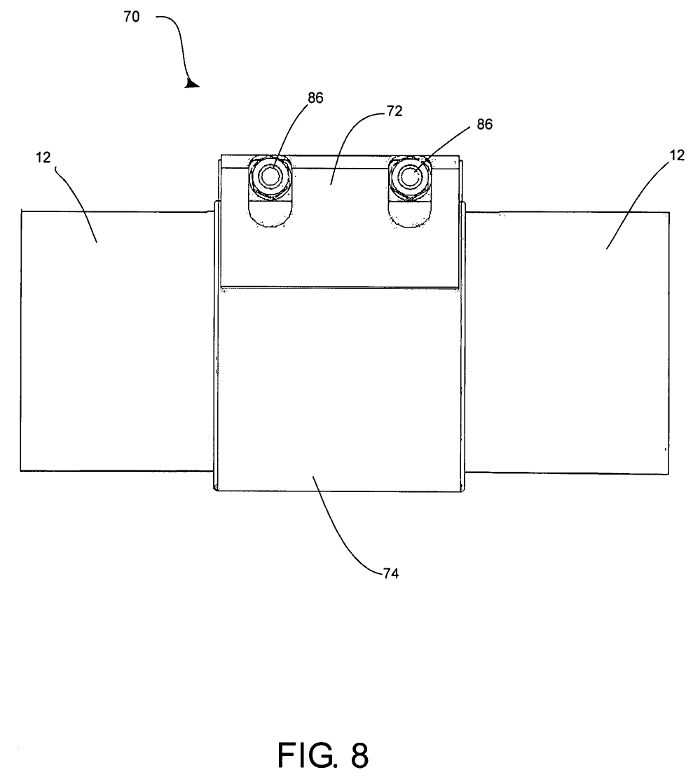

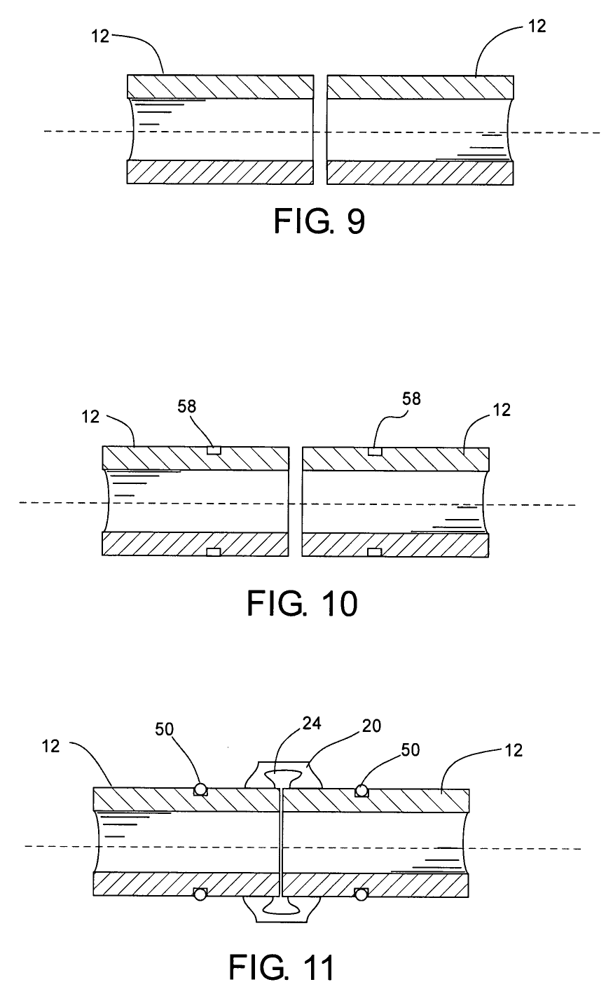

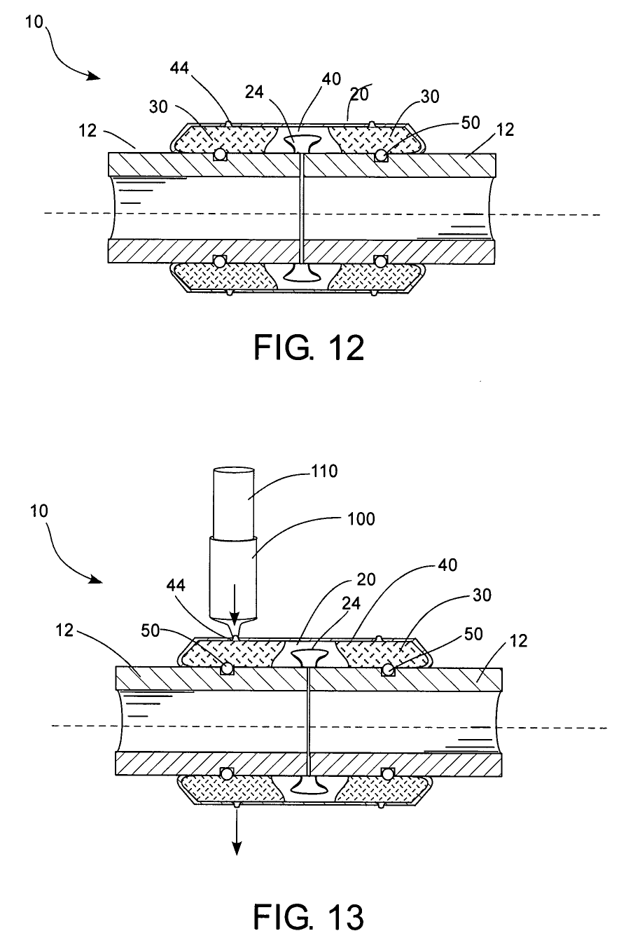

Turning to FIGS. 9-13, the present invention also provides for a method for joining fiberglass or composite pipes including abutting two fiberglass or composite pipes 12, end to end, to form one long continuous pipe with pipe ends adjacent one another, as shown in FIG. 9. The outer diameter surface of each pipe can be prepared adjacent the pipe end. A gasket 20 can be installed around the abutting pipe ends to seal the pipe ends together, as shown in FIG. 11. The gasket 20 can have pressure resistant geometric features 24 to resist pressure from within the pipe ends and pressure from outside the pipe. An annular groove 58 can be formed around each of the pipe ends, as shown in FIG. 10. A locking ring 50 can be placed around the outer diameter of each pipe, and in the grooves, as shown in FIG. 11. At least one fibrous annulus 30 can be placed around the abutted pipes, as shown in FIG. 12. The annulus can be enclosed by a reinforcing sleeve 40, and the reinforcing sleeve can have at least one resin injection port 44, as shown in FIG. 12. Resin can be injected through the at least one resin injection port and into the fibrous annulus, as shown in FIG. 13. The resin can be allowed to cure to form a fiberglass coupling around the abutted pipe ends.

The step of preparing the outer diameter of the pipes can also include cleaning and sanding the outer diameter of the pipe adjacent the pipe ends. Additionally, a groove can be machined into the outer diameter of each pipe near the end of each pipe, as shown in FIG. 10, and the locking rings can be placed into the machined grooves.

The step of placing the at least one fibrous annulus can also include clamping the annulus around the pipes. Additionally, the clamp can be removed from around the annulus after the resin has cured.

The step of injecting the resin, shown in FIG. 13, can also include attaching a resin injection tool, such as a Semco® gun 100, to the resin injection port and engaging the tool to pump or push resin from a resin source, such as a Semco® cartridge 110 filled with resin, through the resin injection port and into the fibrous annulus. Additionally, a bleed port in the reinforcing sleeve can be watched during the resin fill for discharge in order to determine adequate resin injection into the fibrous annulus.

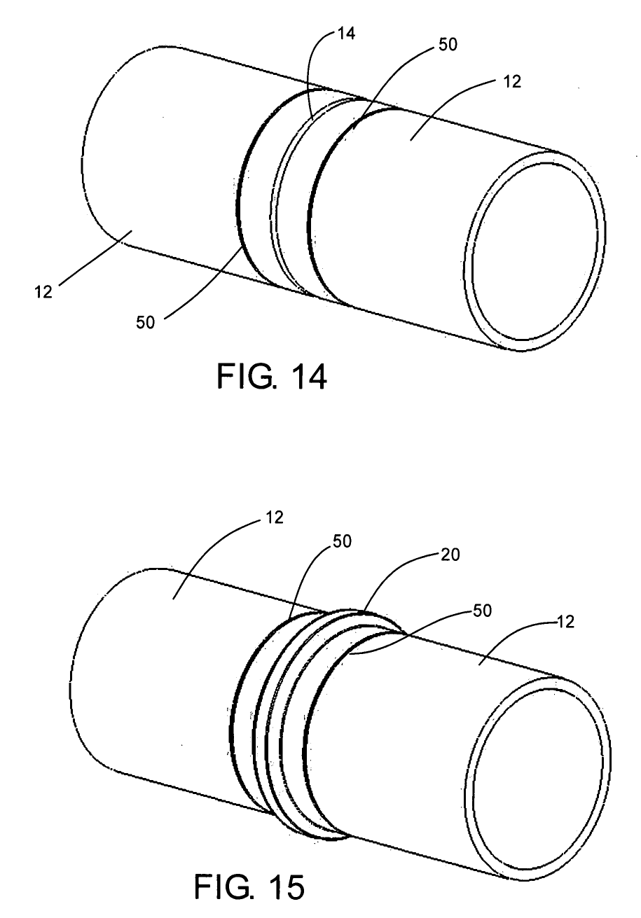

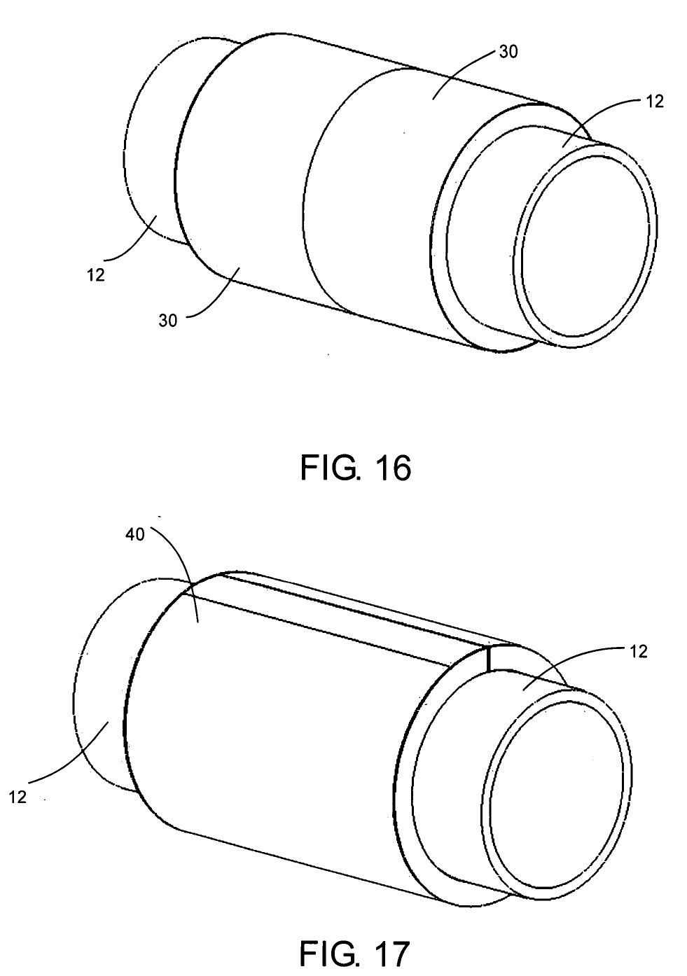

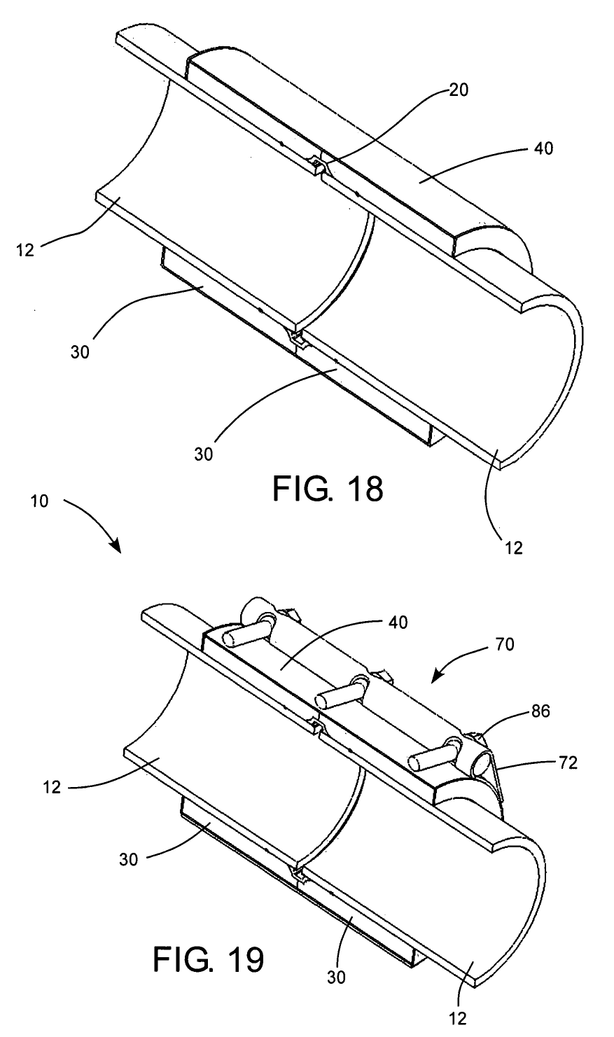

Turning now to FIGS. 14-19, illustrated is a method for forming a fiberglass of composite pipe joint including machining a groove 50 into each of two fiberglass pipes near an end of the pipes. The two fiberglass pipes can then be positioned end to end, with the ends having the machined grooves positioned adjacent one another. Locking rings can then be installed around each of the pipes with the machined groove in each pipe carrying at least a portion of the locking ring, as shown in FIG. 14. A gasket 20 can be placed over the gap between the two pipes with the end of each pipe carrying at least a portion of the gasket, as shown in FIG. 15. A preformed fiber annulus 30 or cylinder can be placed on each pipe adjacent the portion of the gasket being carried by each pipe, as shown in FIG. 16. A sleeve 40 can be positioned over the fiber cylinders and the gasket to enclose the cylinders and gasket within the sleeve, as shown in FIGS. 17 and 18. A pipe clamp 70 can be installed over the sleeve to clamp the sleeve, cylinders and gasket around the fiberglass pipes, as shown in FIG. 19. The clamp can be tightened by turning at least one threaded fastener to pull two opposing ends of the clamp together.

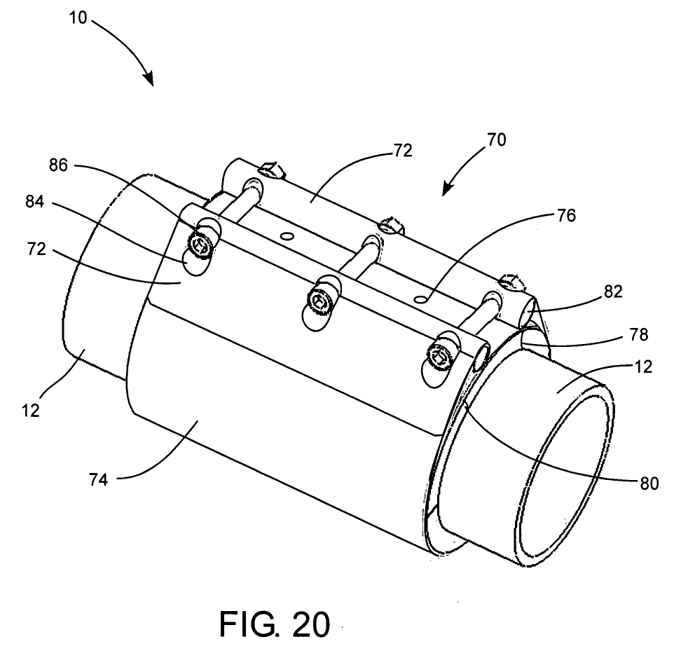

FIG. 20 illustrates another embodiment of a fiberglass or composite pipe joint formed in accordance with the method illustrated in FIGS. 14-19.

The present invention also provides for a method for joining fiberglass or composite pipes, including abutting two fiberglass or composite pipe ends adjacent one another to form a butt joint. A gasket can be installed around the abutting pipe ends. At least one fibrous annulus can be placed around the abutted pipes and over the gasket. A sleeve can be placed around the at least one fibrous annulus, the gasket and the pipe joint. A resin can be introduced to the fibrous annulus. The resin can be allowed to cure.

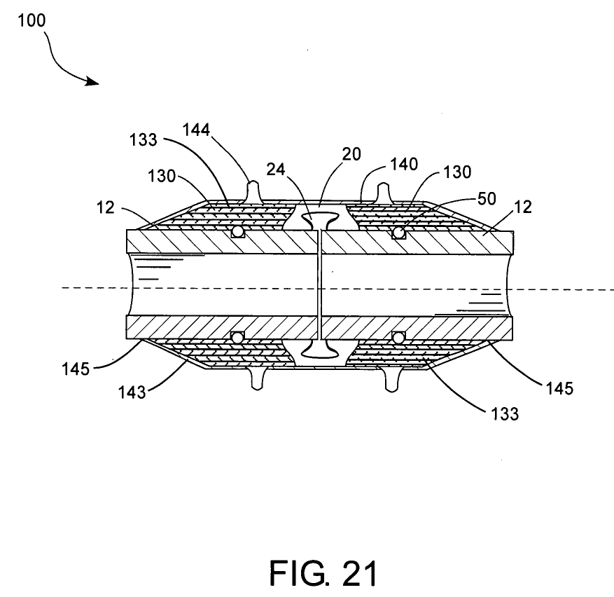

As illustrated in FIG. 21, a pipe joining system, indicated generally at 100, is shown in accordance with another embodiment of the present invention for use in joining the ends of two pipes 12 in a butt joint. The pipe joining system 100 can be similar in many respects to the pipe joining system 10 described above and illustrated in FIGS. 1-8. The pipe joining system 100 can have a gasket 20 disposable about the joined ends of the pipe to seal the pipe to pipe interface 14, and locking rings 50 that can engage the pipe 12 to restrict axial movement of the pipe joining system along the longitudinal axis of the pipe.

Additionally, the pipe joining system 100 can have at least one fibrous annulus 130 disposed circumscribing the pipe and the gasket so as to provide structure and protection to the gasket and the pipe to pipe interface. The fibrous annulus 130 can be formed on the pipe by dry wrapping multiple layers 133 of a fibrous material around the pipe ends to build up the annulus and cover the gasket. The fibrous material can be woven fiber cloth, a chopped fiber mat, a fiber lay-up, a fiber winding, or the like. It will be appreciated that forming the fibrous annulus at the site of the pipe joint can reduce material and production costs related to producing preformed fibrous annuluses.

The pipe joining system 100 can also have an outer sleeve 140 made from a suitable reinforcing material. The sleeve 140 can be formed from a flat sheet 143 of flexible reinforcing material such as plastic or an elastomeric polymer having suitable structural properties as known in the art. The flat sheet 143 can be wrapped around the fibrous annulus 130 and cover the fibrous annulus and the gasket 20. Distal ends 145 of the sleeve 140 can extend beyond the fibrous annulus 130. The distal ends 145 can be sealed by a suitable sealing agent or sealing process to the pipes 12 so as to encapsulate the fibrous annulus 130. In this way, odor from resin introduced to the fibrous annulus 130 can be contained.

The pipe joining system 100 also has at least one resin port 144 extending through the sleeve 140. The resin port facilitates the introduction of resin into the dry fiber material of the fibrous annulus. The resin port can be sized and shaped to provide a sufficient flow of resin so as to infuse and completely wet out the dry fibrous material of the fibrous annulus with resin before the resin begins to cure. After infusion into the fibrous annulus, the resin can be allowed to cure to form a hardened composite ring around the pipe joint.

The present invention also provides for a method for joining fiberglass pipes including abutting two fiberglass pipe ends adjacent one another to form a butt joint. A dry fibrous material can be dry wrapped around the butt joint. A flat sheet of reinforcing material can be wrapped around the dry fibrous material to form a reinforcement sleeve circumscribing the butt joint with distal ends extending beyond the dry fibrous material. The distal ends of the sleeve can be sealed to the fiberglass pipes to encapsulate the dry fibrous material. Resin can be introduced to the fibrous material through an injection port in the reinforcement sleeve. The resin can be allowed to cure to form the pipe joining system as shown in FIG. 21.

The pipe joining systems of the present invention also provide for other advantages. For example, the resin can be injected into the ports, flow around the circumference of the pipes and also flow axially along the pipes in order to fill the fiber annulus filling the area or cavity within the reinforcing sleeve. Resin can exit the bleed port to indicate that the cavity is filled with resin. Additionally, as the resin flows into the cavity, the resin wets out the prepared fiberglass surface of the pipes which helps bond the fibrous annulus to the fiberglass pipes. Furthermore, as the resin flows around the locking rings and cures, a mechanical interference is formed that supplements the shear strength of the bond. Moreover, the resin infused laminate can act to support and restrict the gasket to assure a quality, long-term seal about the abutting pipe end interface. It will also be appreciated that the joining system and method described herein can be used on other types of pipe, including composite or fiber reinforced pipe, or pipe formed of other materials, including metal and plastic.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A pipe joining system to join abutting fiberglass or composite pipe ends, comprising:
a) a gasket, sized and shaped to fit around and seal an interface between the abutting pipe ends;
b) at least one fibrous annulus, sized and shaped to fit around the pipe ends and cover the gasket, the fibrous annulus including dry fibrous reinforcement material capable of receiving resin, and
c) a sleeve, circumscribing the gasket and the at least one fibrous annulus.

2. A system in accordance with claim 1, further including:
at least one locking ring circumscribed by the at least one fibrous annulus and engaging an outer diameter of the fiberglass or composite pipe ends to restrict longitudinal movement of the at least one fibrous annulus along the fiberglass or composite pipe end.

3. A system in accordance with claim 1, further including:
at least one injection port, disposed in the sleeve, the injection port being configured to direct resin into the fibrous annulus.

4. A system in accordance with claim 3, wherein the sleeve further comprises at least one bleed port, configured to release resin from the fibrous annulus so that as resin is injected through the at least one injection port excess resin exits out the bleed port.

5. A system in accordance with claim 1, wherein the gasket is a ring and includes an annular internal cavity in fluid communication with the abutting pipe ends to receive fluid therein from the pipe and restrict the fluid from escaping the internal cavity.

6. A system in accordance with claim 1, wherein the at least one fibrous annulus includes a material selected from the group consisting of fiberglass, carbon fiber, silica fiber, and combinations thereof.

7. A system in accordance with claim 1, wherein the at least one fibrous annulus includes an insulative material to protect the gasket from heat degradation when the fibrous annulus is covering the gasket.

8. A system in accordance with claim 1, wherein the at least one fibrous annulus includes a dry fiberglass material configured to receive a resin.

9. A system in accordance with claim 1, further comprising two fibrous annuluses with each annulus disposed on opposite sides of the gasket.

10. A system in accordance with claim 9, wherein the sleeve includes two injection ports with each of the injection ports positioned to direct resin into a different one of the fibrous annuluses.

11. A system in accordance with claim 9, wherein the sleeve is configured to encapsulate the fibrous annulus to reduce odor from resin injected into the fibrous annulus and to protect the composite resin, the gasket, and ends of the pipe from heat degradation.

12. A system in accordance with claim 1, where in the sleeve includes a material selected from the group consisting of a plastic, a metal, carbon steel, stainless steel, copper, aluminum, a composite material, fiberglass reinforced phenolic, fiberglass reinforced vinyl ester, reinforced fiberglass polyester, reinforced fiberglass epoxy, reinforced epoxy, polyester, vinyl ester, phenolic, and elastomeric polymer, and combinations thereof.

13. A system in accordance with claim 1, further comprising a clamp coupleable around the sleeve, the clamp being sized and shaped to secure the sleeve and the at least one fibrous annulus around the fiberglass or composite pipe ends.

14. A system in accordance with claim 1, wherein the gasket includes a conformable material selected from the group consisting of a gap filler material, putty, a gap covering material, tape, a flexible elastomeric polymer, rubber, and combinations thereof.

15. A method for joining fiberglass or composite pipes, comprising:
a) abutting two fiberglass or composite pipe ends adjacent one another to form a butt joint;
b) installing a gasket around the abutting pipe ends;
c) placing at least one fibrous annulus around the abutting pipe ends and over the gasket;
d) placing a sleeve around the at least one fibrous annulus, the gasket and the pipe joint;
e) introducing a resin to the fibrous annulus; and
f) allowing the resin to cure.

16. A method in accordance with claim 15, further comprising:
placing a locking ring around an outer diameter of each pipe.

17. A method in accordance with claim 16, wherein the fiber annulus engages the locking ring to restrict movement of the at least one fibrous annulus along a longitudinal axis of the pipes.

18. A method in accordance with claim 15, further comprising:
preparing an outer diameter surface of each pipe adjacent the pipe end by cleaning and sanding the outer diameter of the pipe adjacent the pipe ends;
machining a groove into the outer diameter of each pipe near the end of each pipe; and
placing a locking ring into each of the machined grooves.

19. A method in accordance with claim 15, wherein the gasket seals the pipe ends together, the gasket having an annular internal cavity sized and shaped to receive fluid from within the pipe ends.

20. A method in accordance with claim 15, wherein the sleeve includes at least one resin injection port.

21. A method in accordance with claim 20, wherein the step of introducing the resin further includes attaching a resin injection tool to the resin port and engaging the tool to inject resin into the at least one fibrous annulus.

22. A method in accordance with claim 21, wherein the step of injecting the resin further includes watching for resin discharge through a resin discharge port disposed in the reinforcing sleeve to determine adequate resin injection into the at least one fibrous annulus.

23. A method in accordance with claim 15, further comprising:
placing a clamp around the sleeve to clamp the sleeve around the at least one fibrous annulus.

24. A method in accordance with claim 15, further comprising:
removing the clamp from around the fiber annulus after the resin has cured.

25. A method in accordance with claim 15, wherein the sleeve includes means for clamping the at least one fibrous annulus around the pipe.

26. A method in accordance with claim 15, wherein the annular reinforcement sleeve includes an adjustable annular sleeve with an adjustable circumference.

27. A method in accordance with claim 26, further comprising tightening the adjustable annular sleeve to seal ends of the sleeve against the pipe.

28. A method in accordance with claim 15, further comprising:
removing the sleeve after the resin has cured.

29. A method for joining fiberglass or composite pipes, comprising:
a) abutting two fiberglass or composite pipe ends adjacent one another to form a butt joint;
b) dry wrapping a dry fibrous material around the butt joint;
c) wrapping a flat sheet of reinforcing material around the dry fibrous material to form a reinforcement sleeve circumscribing the butt joint with distal ends extending beyond the dry fibrous material;
d) sealing the distal ends of the sleeve to the fiberglass or composite pipes to encapsulate the dry fibrous material;
e) introducing resin to the fibrous material through an injection port in the reinforcement sleeve; and
f) allowing the resin to cure.
